(19) United States
(12) Patent Application Publication
(10) Pub. No.: US 2008/0048612 A1
(43) Pub. Date: Feb. 28, 2008

(54) Wireless battery charger

(76) Inventor: Sheng-i Yang, Jhonghe City (TW)

Correspondence Address: BIRCH STEWART KOLASCH & BIRCH, PO BOX 747, FALLS CHURCH, VA, 22040-0747, US

(21) Appl. No.: 11/507,579

(22) Filed: Aug. 22, 2006

(51) Int. Cl. H02J 7/00

(52) U.S. Cl. 320/108

(57) ABSTRACT

A wireless battery charger comprises of a housing, a processing module, and a rechargeable battery. The housing has a socket, at least one terminal mounted on at least one inner wall of the socket, a first display unit, and a second display unit. The processing module mounted in the housing has a printed circuit board electrically connected to the terminal, at least one connector mounted on the printed circuit board and corresponding to an outer periphery of the housing, a switch, a power indicator corresponding to the first display unit, a charging indicator corresponding to the second display unit, and a plurality of electronic components. The rechargeable battery is received in the housing and electrically connected to the printed circuit board. The rechargeable battery can be fully pre-charged prior to taking the wireless battery charger outdoors for immediately charging a rechargeable battery used in a portable electronic appliance.

### FIELD OF THE INVENTION

The present invention relates to a battery charger, and more particularly to a wireless battery charger having a rechargeable battery which is pre-charged prior to taking the wireless battery charger outdoors for immediately charging rechargeable batteries of electronic appliances such as digital camera, digital video camera, personal digital assistance, etc.

### BACKGROUND OF THE INVENTION

Referring now to FIG. 5, a conventional battery charger is illustrated, which comprises a casing 6 provided with a socket 61. The socket 61 has two opposite inner walls provided with a plurality of terminals 62 electrically connected to a processing module 63 having a switch 631. The processing module 63 is electrically connected to a power unit 64 mount on an outer surface of the casing 6. The power unit 64 is formed with a wire 642 and a plug 641 connected with the wire 642. Alternatively, the power unit 64 is a plug integrally formed on the outer surface of the casing 6. In use, at least one rechargeable battery 7 can be inserted into the socket 61 for electrically connecting to the terminals 62, and the power unit 64 is electrically connected to an outer power source. Then, turning on the switch 631 for supplying an outer electric power from the power unit 64 to the processing module 63 so at to convert the outer electric power into a suitable electric power used for charging the rechargeable battery 7.

Although the conventional battery charger converts the outer electric power into the suitable electric power by the processing module 63 for charging the rechargeable battery 7, the outer electric power is supplied from the outer power source, such as a power receptacle mounted on an indoor wall, via the power unit 64. In use, the plug 641 of the power unit 64 must be inserted into the power receptacle mounted on the indoor wall so that the power unit 64 confines the use of the conventional battery charger in an indoor environment. It is resulted in that the conventional battery charger can not be taken outdoors for being used as a portable battery charger to immediately charge the rechargeable battery 7 of electronic appliances. Furthermore, when going abroad, a user may carry the conventional battery charger for charging the rechargeable battery 7 of electronic appliances to avoid the electronic appliances losing power and stopping working. But, if the specification of the plug 641 of the power unit 64 is different from that of the power receptacle in the foreign area, there would be no outer electric power can be supplied to the conventional battery charger via the plug 641 of the power unit 64. To overcome the problem as described above, some user carries a plurality of rechargeable battery 7 of electronic appliances or several battery chargers with different specifications when going abroad. This is obviously not a good design from simplicity, efficiency, and practicability.

It is therefore tried by the inventor to develop a wireless and portable battery charger to solve the problems existed in the conventional battery chargers.

### SUMMARY OF THE INVENTION

A primary object of the present invention is to provide a wireless battery charger, which is provided with a processing module having at least one connector via a removable wire for supplying an outer electric power to fully pre-charge at least one rechargeable battery mounted in the wireless battery charger prior to taking the wireless battery charger outdoors for immediately charging at least one rechargeable battery used in at least one portable electronic appliance such as digital camera, digital video camera, personal digital assistance, and etc.

To achieve the above and other objects, the wireless battery charger according to a preferred embodiment of the present invention comprises a housing, a processing module, and at least one rechargeable battery. The housing is provided with a socket recessed in its one side, at least one terminal mounted on at least one inner wall of the socket, a first display unit adjacent to the socket, and a second display unit adjacent to the socket. The processing module mounted in the housing is provided with a printed circuit board electrically connected to the terminal, at least one connector mounted on the printed circuit board and corresponding to an outer periphery of the housing, a switch corresponding to another outer periphery of the housing, a power indicator corresponding to the first display unit, a charging indicator corresponding to the second display unit, and a plurality of other electronic components. The rechargeable battery is received in the housing and electrically connected to the printed circuit board.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a wireless battery charger according to a preferred embodiment of the present invention;

FIG. 2 is an exploded perspective view of the wireless battery charger according to the preferred embodiment of the present invention;

FIG. 3 shows the wireless battery charger according to the preferred embodiment of the present invention in use, which has a rechargeable battery pre-charged via a removable wire;

FIG. 4 shows the wireless battery charger according to the preferred embodiment of the present invention in use, which is used to charge a rechargeable battery of other electronic appliance; and

FIG. 5 is an exploded perspective view of a conventional battery charger.

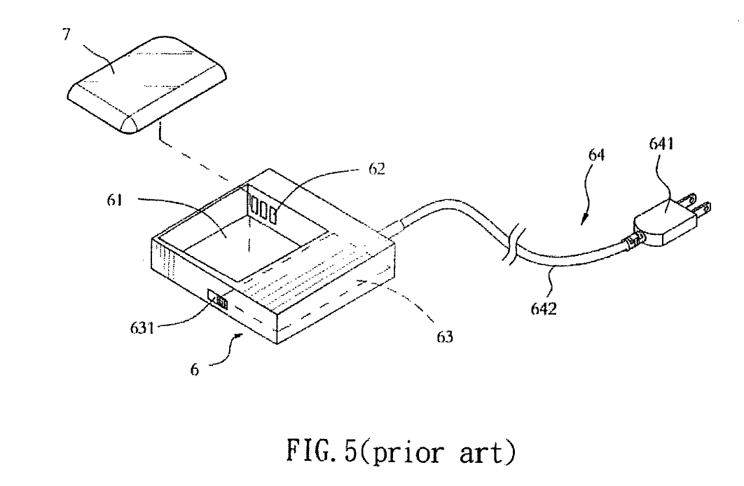

### DETAILED DESCRIPTION OF THE PREFERRED EMBODIMENTS

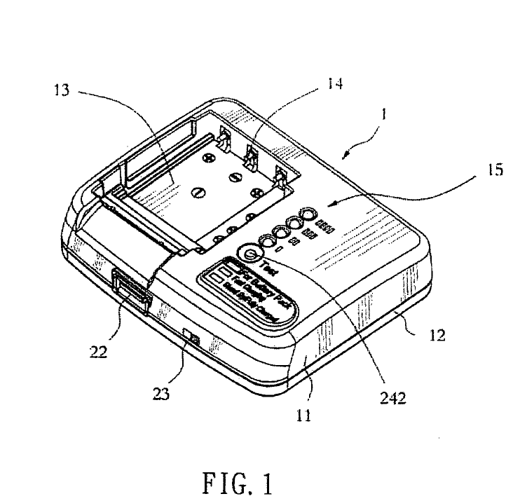

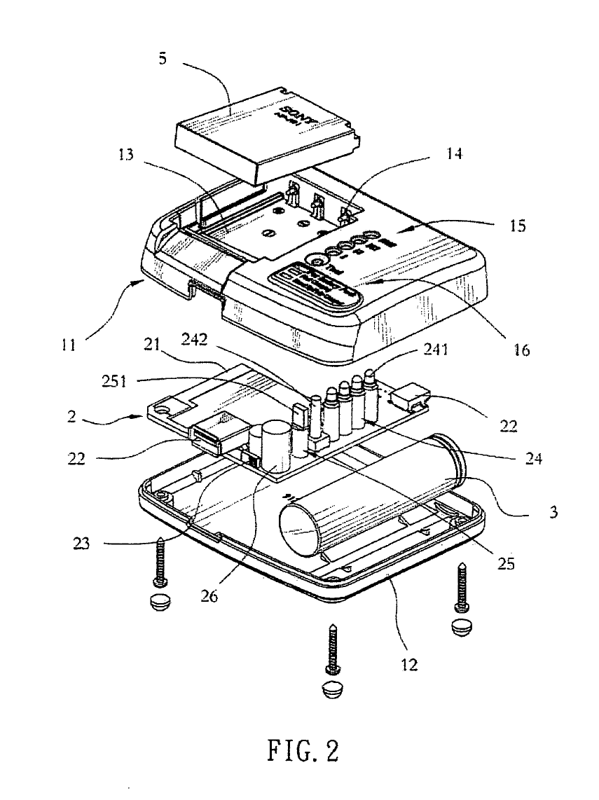

Referring now to FIGS. 1 and 2 that are an assembled perspective view and an exploded view, respectively, of a wireless battery charger according to a preferred embodiment of the present invention. As shown, the present invention includes a housing 1, a processing module 2, and at least one rechargeable battery 3 capable of being fully pre-charged prior to taking the wireless battery charger outdoors for immediately charging at least one rechargeable battery used in at least one portable electronic appliance such as digital camera, digital video camera, personal digital assistance, and etc.

Referring back to FIGS. 1 and 2, the housing 1 of the preferred embodiment of the present invention has an upper half 11 and a lower half 12, and the upper half 11 is provided with a socket 13 recessed in one side thereof. The socket 13 can be used to accommodate various rechargeable batteries with different specifications, and at least one inner wall of the socket 13 is formed with at least one terminal 14. The upper half 11 is further provided with a first display unit 15 adjacent to the socket 13, and a second display unit 16 adjacent to the socket 13.

Referring to FIGS. 1 and 2 again, the processing module 2 of the preferred embodiment of the present invention is mounted in the housing 1, and is provided with a printed circuit board 21 electrically connected to the terminal 14, at least one connector 22 mounted on the printed circuit board 21 and corresponding to an outer periphery of the housing 1, a switch 23 corresponding to another outer periphery of the housing 1, a power indicator 24 mounted on the printed circuit board 21 and having a plurality of indicator lights 241 corresponding to the first display unit 15 and a button 242 protruded out of the housing 1, a charging indicator 25 mounted on the printed circuit board 21 and having a plurality of indicator lights 251 corresponding to the second display unit 16, and a plurality of other electronic components 26 mounted on the printed circuit board 21.

Referring to FIGS. 1 and 2 again, the rechargeable battery 3 of the preferred embodiment of the present invention is received in the housing 1, and electrically connected to the printed circuit board 21 of the processing module 2. The rechargeable battery 3 is preferably selected from a high capacity lithium-ion battery or other equivalent battery. The housing 1, the processing module 2, and the rechargeable battery 3 are constituted the wireless battery charger of the preferred embodiment of the present invention.

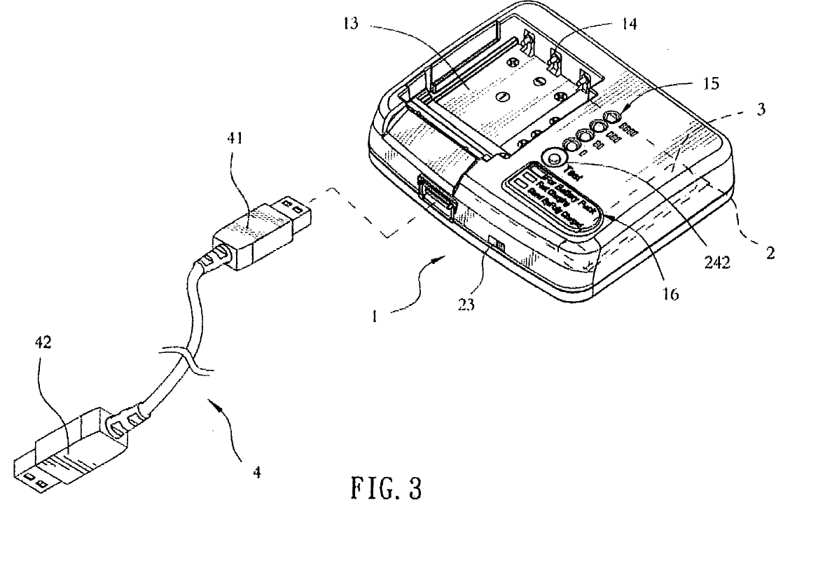

Referring now to FIG. 3 that is the wireless battery charger according to the preferred embodiment of the present invention in use. A removable wire 4 is provided with a first connector 41 and a second connector 42. The first connector 41 is electrically connected to the connector 22 mounted on the outer periphery of the housing 1 while the second connector 42 electrically connected to an outer power source for supplying an outer electric power in order to fully pre-charge the rechargeable battery 3 via the processing module 2. Meanwhile, the button 242 of the power indicator 24 can be selectively pressed to actuate the printed circuit board 21 for obtaining a signal of the power capacity of the rechargeable battery 3 so that the indicator lights 241 of the power indicator 24 immediately display the degree of the power capacity of the rechargeable battery 3 via the first display unit 15. After the rechargeable battery 3 is fully pre-charged, disconnecting the first connector 41 of the removable wire 4 from the connector 22 of the housing 1. In this manner, the wireless battery charger according to the preferred embodiment of the present invention can be taken outdoors and standby for use.

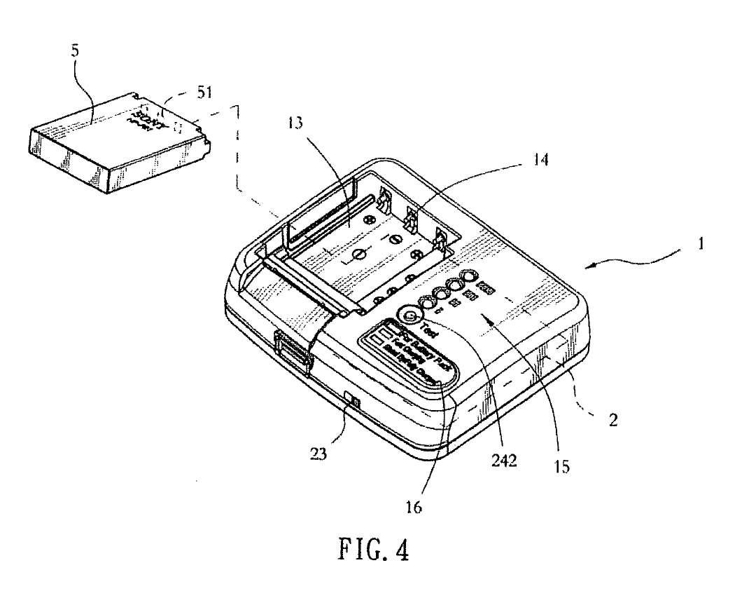

Referring now to FIG. 4 that is the wireless battery charger according to the preferred embodiment of the present invention in use. When the wireless battery charger is taken outdoors, it is standby for charge at least one rechargeable battery 5 of at least one portable electronic appliance such as digital camera, digital video camera, personal digital assistance, and etc. In use, turning on the switch 23 mounted on the outer periphery of the housing 1, and then the indicator lights 251 of the charging indicator 25 display a standby signal of the rechargeable battery 3 on the second display unit 16. Then, the rechargeable battery 5 can be inserted into the socket 13 of the housing 1 until at least one terminal 51 of the rechargeable battery 5 is electrically connected to the terminal 14 in the socket 13. In this manner, the electric power of the rechargeable battery 3 is supplied to the rechargeable battery 5 via the processing module 2 and the terminal 14. After the rechargeable battery 5 is fully charged, the indicator lights 251 of the charging indicator 25 display a full-charged signal of the rechargeable battery 5 via the second display unit 16 so that the rechargeable battery 5 can be removed from the socket 13 of the housing 1, and the switch 23 is turned off later.

As described above, the wireless battery charger according to the preferred embodiment of the present invention is supplied the outer electric power to fully pre-charge the rechargeable battery 3 via the removable wire 4 and the connector 22 of the processing module 2 so that the wireless battery charger can be taken outdoors for immediately charging at least one rechargeable battery 5 used in at least one portable electronic appliance such as digital camera, digital video camera, personal digital assistance, and etc. In other word, the wireless battery charger is a wireless and portable battery charger which is a good design from simplicity, efficiency, and practicability.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A wireless battery charger, comprising:
a housing provided with a socket recessed in one side of the housing, at least one terminal mounted on at least one inner wall of the socket, a first display unit adjacent to the socket, and a second display unit adjacent to the socket;
a processing module mounted in the housing and provided with a printed circuit board electrically connected to the terminal, at least one connector mounted on the printed circuit board and corresponding to an outer periphery of the housing, a switch corresponding to another outer periphery of the housing, a power indicator corresponding to the first display unit, a charging indicator corresponding to the second display unit, and a plurality of electronic components; and
a rechargeable battery received in the housing and electrically connected to the printed circuit board of the processing module.

2. The wireless battery charger as claimed in claim 1, wherein said the housing has an upper half and a lower half.

3. The wireless battery charger as claimed in claim 1, wherein said power indicator comprises a plurality of indicator lights and a button.

4. The wireless battery charger as claimed in claim 1, wherein said charging indicator comprises a plurality of indicator lights.

5. The wireless battery charger as claimed in claim 1, wherein said rechargeable battery is a high capacity lithium-ion battery.
